(19) United States
(12) Patent Application Publication
(10) Pub. No.: US 2026/0145495 A1
(43) Pub. Date: May 28, 2026

(54) ACCORDION-STYLE COVER OR DOOR ARRANGEMENT

(71) Applicant: BOS Automotive Products, Inc., Rochester Hills, MI (US)

(72) Inventors: Abhishikt KOWTHA, Clarkston, MI (US); Satya Akhil Reddy BACHUGUDAM, Rochester Hills, MI (US)

(21) Appl. No.: 19/399,809

(22) Filed: Nov. 25, 2025

Related U.S. Application Data
(60) Provisional application No. 63/724,993, filed on Nov. 26, 2024.

(51) Int. Cl. B60J 7/04; B60J 7/19

(52) U.S. Cl. CPC B60J 7/041; B60J 7/196; B60J 7/198

(57) ABSTRACT

An arrangement for use as a cover for a window or door, as a door or as a cover for a cargo space of a vehicle. The arrangement includes a housing with a hollow interior and a mouth, the hollow interior of the housing opening outwardly to an exterior environment of the cover or door arrangement through the mouth. A pair of track members are disposed along the respective sides of the housing and a slat assembly is located within the housing. The slat assembly is movable between a retracted storage configuration and an extended covering configuration, and when in the retracted storage configuration the slat assembly is disposed substantially within the housing. The slat assembly includes a plurality of rigid slats pivotably interconnected to one another in an accordion configuration and movably engaged with the track members.

### CROSS-REFERENCE TO RELATED APPLICATION

This claims priority from U.S. Provisional Application Ser. No. 63/724,993, filed Nov. 26, 2024, the disclosure of which is hereby incorporated by reference in its entirety.

### TECHNICAL FIELD

This relates to an accordion-style cover arrangement for use in a cargo space of a vehicle, as a protective cover arrangement for a window or door in a building, or as a door arrangement.

### BACKGROUND AND SUMMARY

Motor vehicles, such as pickup trucks, have a cabin for seating passengers and a bed for hauling cargo. The bed of the truck is open to the outside environment, and thus any cargo in the bed is necessarily exposed to the elements. Other types of vehicles, such as passenger cars, sport utility vehicles (SUVs), cross-over vehicles (CUVs) and electric vehicles (EVs), have an interior cargo space used for storing and transporting various types of items. In the case of a truck, it is undesirable to subject certain types of cargo to weather. Further, some vehicle owners, whether the vehicle is a pickup truck or any of the other types of vehicles mentioned above, do not want cargo to be readily visible when stored in the vehicle interiorly or exteriorly thereof. It is accordingly desirable to provide such cargo storage spaces in vehicles with a cover movable into an open position to provide access to the cargo space and into to a closed position to prevent access to and visibility of the cargo space.

Additionally, covers or shutters are used on residential and commercial buildings as protection against weather and/or to deter or prevent unlawful entry into such buildings. Such covers or shutters are typically installed over doors and windows and are retractable into a storage position when protection is not needed, and are extendable out of the storage position so as to cover the window or door for protection against weather or to prevent unauthorized entry into the building.

Further, retractable doors are often used to secure and cover openings in residential or commercial buildings, for example garage doors or storage unit doors.

The invention is directed to a cover or door arrangement which may be utilized in any of the above-described applications, and according to one aspect includes a housing defining a hollow interior and a mouth, the hollow interior of the housing opening outwardly to an exterior environment of the cover or do or arrangement through the mouth. The housing also includes first and second spaced-apart sides oriented transversely to the mouth, a pair of elongate and spaced-apart track members disposed along the respective first and second sides of the housing and a slat assembly. The slat assembly is movable between a retracted storage configuration and an extended covering configuration, and when in the retracted storage configuration is disposed substantially within the housing. The slat assembly includes a plurality of rigid slats pivotably interconnected to one another in an accordion configuration and movably engaged with the track members. Each of the slats has oppositely facing first and second sides with the first sides having an exterior surface portion facing outwardly when the slat assembly is in the extended covering configuration. The exterior surface portions when the slat assembly is in the extended covering configuration are oriented in a substantially coplanar manner with one another, and one of the slats is an end slat positionally disposed in the slat assembly such that the one end slat is a first of the slats to exit the housing through the mouth thereof when the slat assembly is moved from the retracted storage configuration to the extended covering configuration. In one embodiment, the slat assembly includes a handle operatively connected to the end slat for manually moving the slat assembly between the retracted storage configuration and the extended covering configuration. In another embodiment, the slat assembly is driven by a drive arrangement which drives the end slat, which end slat in turn drives the remaining slats.

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the object being described and of designated parts thereof. Further, the terms “front” or “frontwardly” and “rear” or “rearwardly”, or equivalent terms, when used to describe various components of the arrangement will be in reference to the position of the components when the arrangement is installed on a vehicle in a rear-facing cargo or storage space or installed in a truck bed adjacent a rear window of the truck and in reference to a front-to-back direction of the motor vehicle. Said terminology will include the words specifically mentioned, derivatives thereof, and words of similar import.

### BRIEF DESCRIPTION OF THE DRAWINGS

FIG. 1 is a perspective and fragmentary view of the arrangement;

FIG. 2 is a perspective and fragmentary view of the arrangement in the extended covering configuration and incorporated into a motor vehicle, and specifically a pickup truck;

FIG. 3 is a fragmentary view illustrating the arrangement incorporated into a building;

FIG. 4 is an exploded view of the arrangement;

FIG. 5 is perspective view of the cartridge of the arrangement;

FIG. 6 is a fragmentary top view of the cartridge;

FIG. 7 is a fragmentary cross-sectional view of the cartridge as seen generally along line 7-7 in FIG. 6;

FIG. 8 is a bottom perspective view of the cartridge;

FIG. 9 is a view of the cartridge as seen generally from the direction indicated by the arrow A in FIG. 6;

FIG. 10 is a perspective view of the outer side of one of the cartridge side frames;

FIG. 11 is a further perspective view of the outer side of the cartridge side frame shown in FIG. 10;

FIG. 12 is perspective view of the inner side of the cartridge side frame shown in FIG. 10;

FIG. 13 is a further perspective view of the inner side of the cartridge side frame shown in FIG. 10;

FIG. 14 is a side view of the outer side of the cartridge side frame shown in FIG. 10;

FIG. 15 is a side view of the inner side of the cartridge side frame shown in FIG. 10;

FIG. 15A is an enlarged cross-sectional view of the cartridge side frame as seen generally along line 15A-15A in FIG. 15;

FIG. 16 is a perspective view of one of the slat connectors of the slat linkage assembly;

FIG. 17 is a fragmentary top view of the arrangement;

FIG. 18 is a cross-sectional and fragmentary view of the arrangement as seen generally along line 18-18 in FIG. 17;

FIGS. 18A and 18B are an enlarged detail views of FIG. 18;

FIG. 19 is a fragmentary cross-sectional view as seen generally along line 19-19 in FIG. 17;

FIG. 20 is a fragmentary cross-sectional view of the arrangement illustrating the slat assembly moving out of the retracted storage configuration and towards the extended covering configuration;

FIG. 21 is a fragmentary cross-sectional view of the arrangement illustrating further advancement of the slat assembly towards the extended covering configuration;

FIG. 22 is a perspective fragmentary view of the arrangement in the extended covering configuration of the slat assembly;

FIG. 23 is an enlarged fragmentary cross-sectional view of the cover or door arrangement similar to FIG. 19, but which illustrates the springs installed between adjacent slats;

FIG. 24 is an enlarged and fragmentary view of the slats illustrating the seals between adjacent slats;

FIG. 25 is an enlarged perspective view of two adjacent interconnected slats;

FIG. 26 is a diagrammatic illustration of a further embodiment of the arrangement installed within a bed of a pickup truck and in the use position;

FIG. 27 is a diagrammatic illustration of the arrangement of FIG. 26 in the intermediate position;

FIG. 28 is a diagrammatic illustration of the arrangement of FIG. 26 in the stored, non-use position;

FIG. 29 is an enlarged, fragmentary and diagrammatic perspective view of the slat locking arrangement;

FIG. 30 is a fragmentary and diagrammatic cross-sectional illustration of an alternative embodiment of the slat-sealing arrangement, with the slats in the extended covering position;

FIG. 31 is a fragmentary and diagrammatic cross-sectional illustration of the slat-sealing arrangement of FIG. 30, with the slats in a partially retracted configuration;

FIG. 32 is a fragmentary and diagrammatic cross-sectional illustration of the slat-sealing arrangement of FIG. 30, with the slats in the fully retracted storage configuration;

FIG. 33 is a fragmentary perspective view of an alternative embodiment of the arrangement incorporating a modified slat-sealing arrangement, with the slat assembly in the extended covering position;

FIG. 34 is an enlarged fragmentary cross-sectional view as seen generally along line 34-34 in FIG. 33;

FIG. 35 is a perspective view of the arrangement of FIG. 33 with the slat assembly in the retracted configuration;

FIG. 36 is a top view of the arrangement of FIG. 33, with the slat assembly in the retracted configuration; and

FIG. 37 is an enlarged cross-sectional view as seen generally along line 37-37 in FIG. 36.

### DETAILED DESCRIPTION

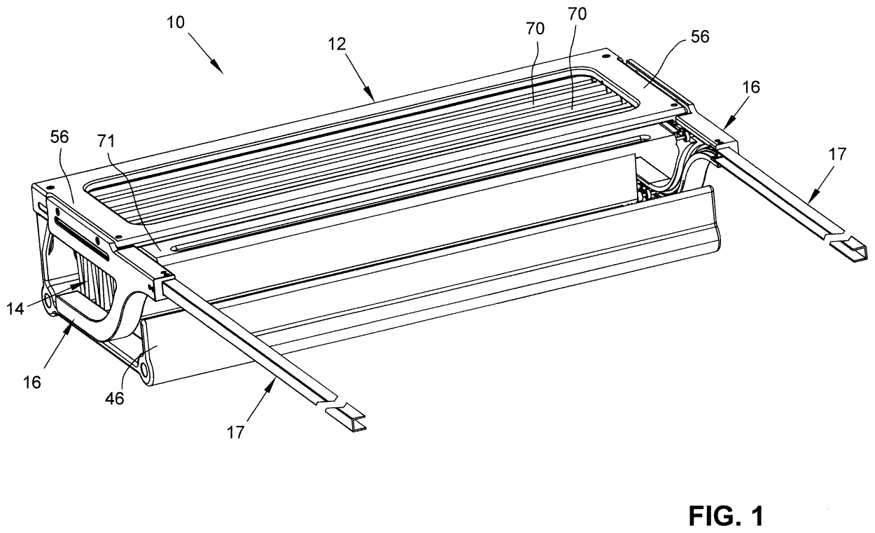

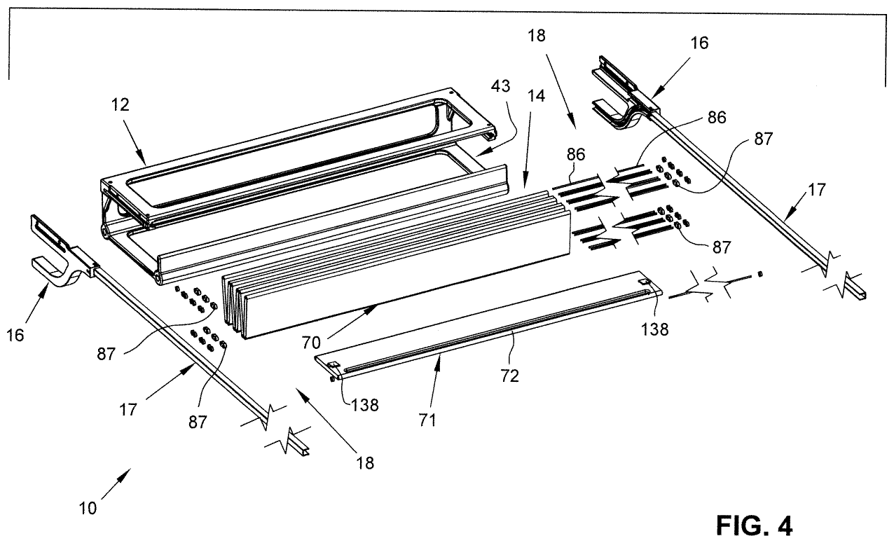

FIGS. 1 and 4 illustrate a cover or door arrangement 10 (hereinafter simply referred to as “the arrangement”), which generally includes a cartridge or magazine or housing 12, a pair of cartridge side frames 16 fixed to opposite sides of the cartridge 12, a pair of channel members or rails 17, a slat assembly 14 and a slat linkage assembly 18. The slat assembly 14 is normally housed within the cartridge 12 and is extendable therefrom.

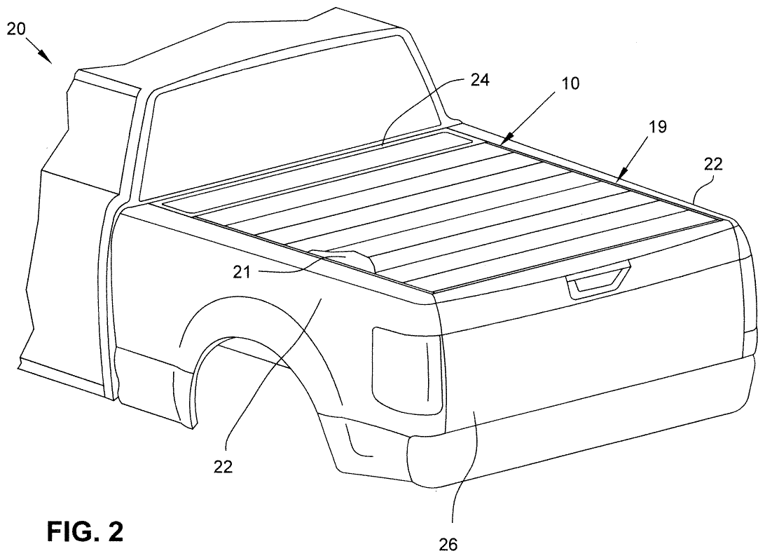

One use of the arrangement 10 is shown in FIG. 2, in which the arrangement 10 is incorporated into a motor vehicle 20. The motor vehicle 20 is a pickup truck having a bed 21 defined by a pair of laterally-spaced side walls 22, a front wall 24 and a tailgate 26. In FIG. 2, the slat assembly 14 of the arrangement 10 is in the fully extended configuration, and in this configuration defines a generally planar cover 19 which extends over and closes off the truck bed 21. It will be appreciated that the arrangement 10 may instead be utilized in a front or rear cargo space of a passenger vehicle, such as a passenger car, a sport utility vehicle (SUV), a cross-over vehicle (CUV) or an electric vehicle (EV).

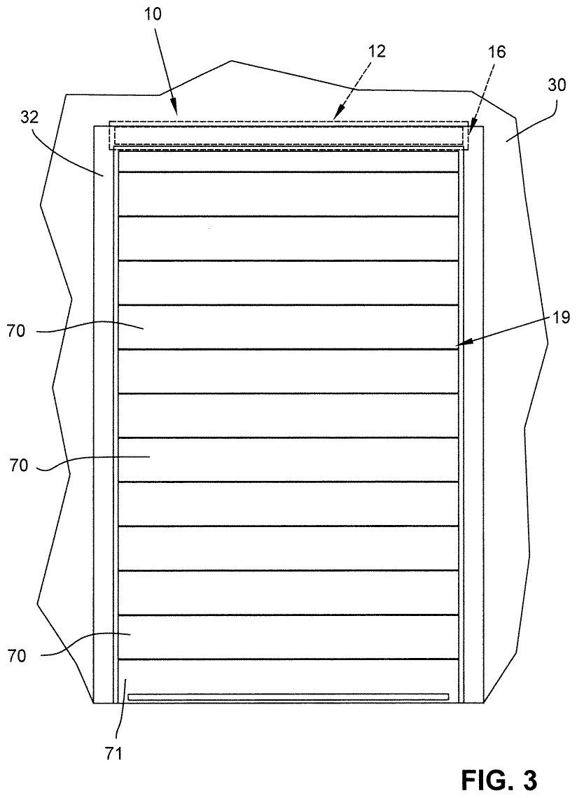

The arrangement 10 may alternatively be incorporated into a building or a permanent or temporary storage structure 30, as shown in FIG. 3. In this regard, the arrangement 10 may itself serve as a door for ingress/egress purposes and be installed within a door frame 32, or may serve as a cover or shutter for a window or door by being installed in superimposed relation with the window or door to prevent damage from weather or unauthorized access to the structure in which the window or door is installed.

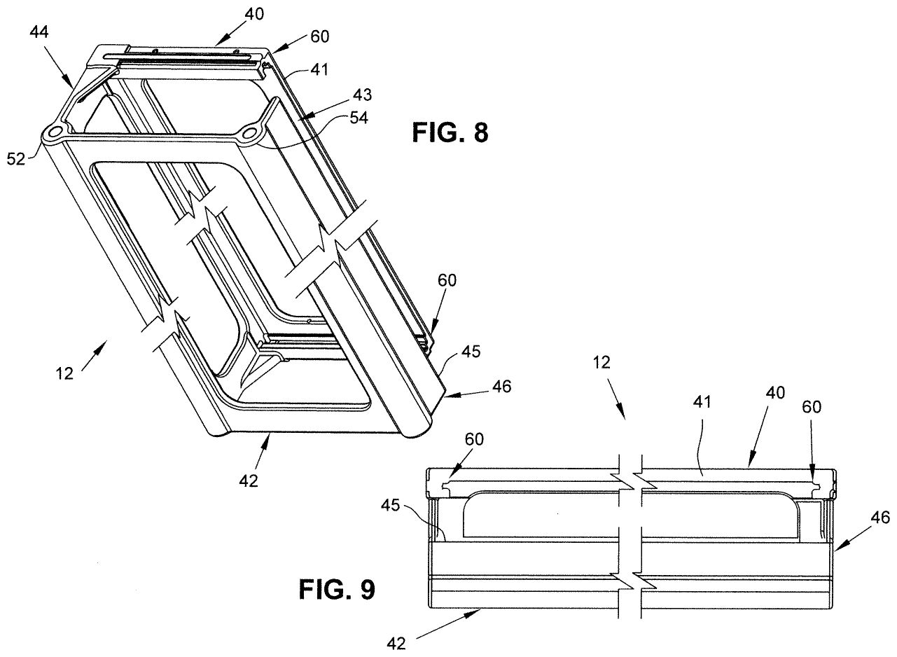

With reference to FIGS. 1 and 4-9, the cartridge 12 includes an upper frame 40, a lower frame 42 spaced from the upper frame 40 by a front frame 44 which interconnects the frames 40 and 42, and a rear side wall 46. In the illustrated embodiment, the rear side wall 46 is joined to and projects upwardly from a rear edge portion of the lower frame 42, is approximately one-half the height of the front frame 44 and terminates at a rear longitudinal edge portion 45. The upper frame 40 in the illustrated embodiment, in a front-to-back direction, is of a shorter dimension than the lower frame 42 and has a terminal free edge portion 41. The rear edge portion 45 of the rear side wall 46 and the terminal edge portion 41 of the upper frame 40 are spaced from one another and together define a cartridge mouth 43 which opens rearwardly. While the upper frame 40, the lower frame 42 and the front frame 44 are depicted as open structures, it will be appreciated that these components may instead be provided as solid components. However, the open-frame construction of the cartridge 12 reduces the weight of the overall arrangement 10, which is desirable for handling and installation purposes. In the illustrated embodiment, the cartridge 12, at a junction where the front frame 44 is joined to the lower frame 42, includes an elongate cylinder 52 which defines therein a through opening.

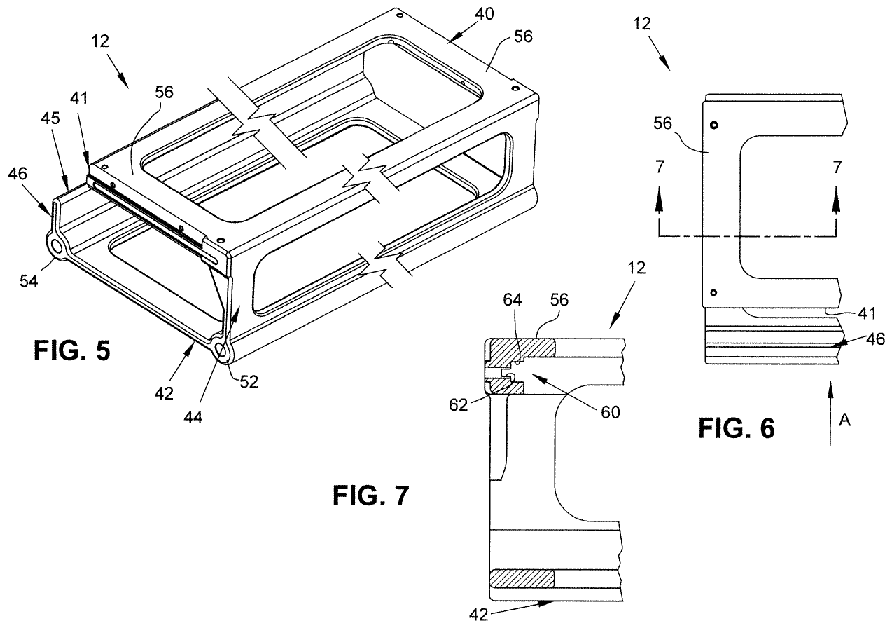

With reference to FIGS. 5-9, the upper frame 40 of the cartridge 12 includes a pair of substantially parallel upper frame members 56. Each of the upper frame members 56 along inner sides thereof define respective stepped tracks 60. The stepped tracks 60 open inwardly and towards one another along all or a majority of a front-to-back dimension of the upper frame members 56. Each of the stepped tracks 60 includes an outer elongate track part 62 and an inner elongate track part 64. The inner track part 64 is in communication with the outer track part 62, and is of a greater vertical dimension than the outer track part 64. The stepped tracks 60 additionally open rearwardly through the rear edge portion 41 of the upper frame 40.

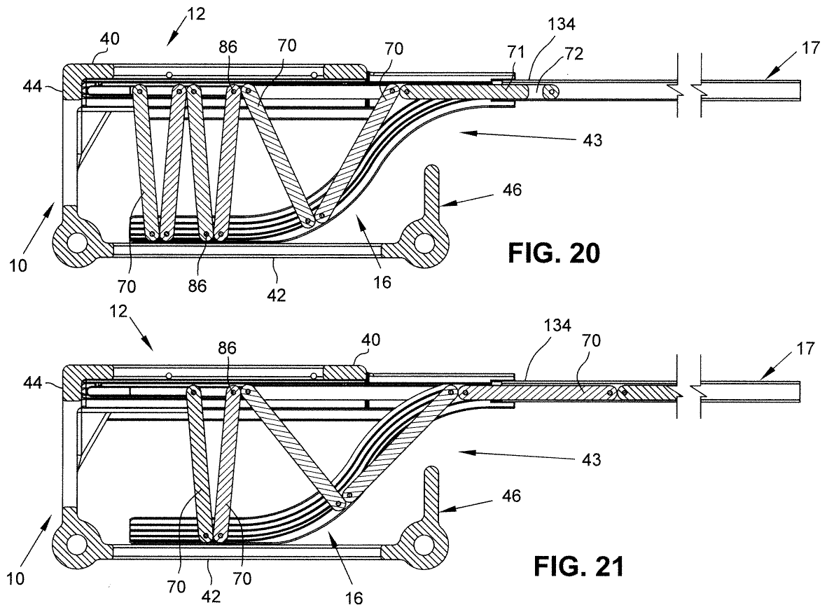

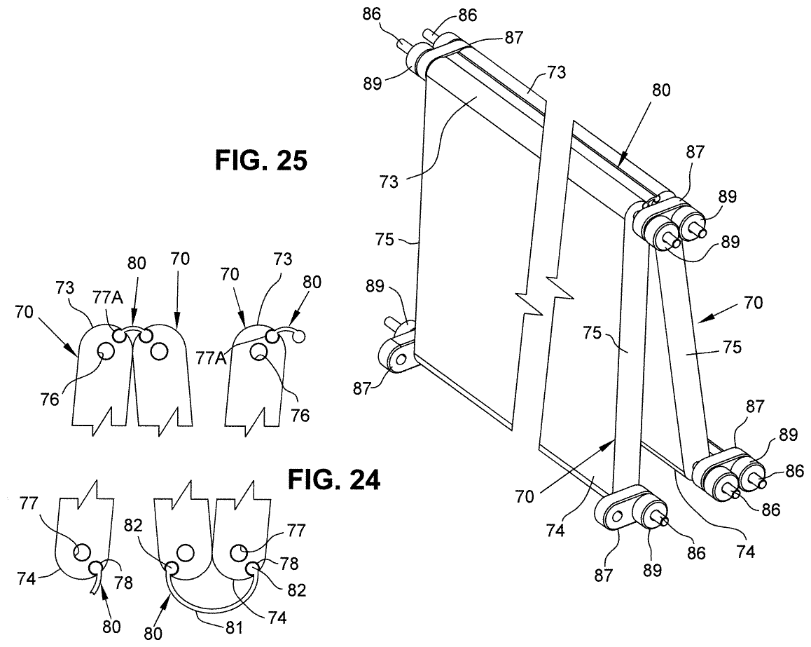

Turning now to the slat assembly 14 and with reference to FIGS. 4 and 19-25, same includes a plurality of individual elongated slats 70 and a rear elongated slat 71 having an elongated opening 72 which serves as a handle. The slats 70 and rear slat 71 are planar and generally rectangular-shaped components and are substantially identical to one another, and the same reference numbers will therefore be used for the common features of the slats 70 and the rear slat 71. The slats 70 and 71 each have upper and lower elongated end portions 73 and 74 which are generally parallel with each other, and lateral edge portions 75 which extend between the upper and lower end portions 73 and 74 of the respective slat on opposite sides thereof. Each of the upper and lower end portions 73 and 74 defines therein an elongate through hole 76 and 77. The through holes 76 and 77 extend along the entire longitudinal extent of each upper and lower end portion 73 and 74 and open outwardly through the respective lateral edge portions 75 of the slat. With reference to FIG. 24, the upper and lower end portions 73 and 74 of each slat 70 and 71 define therein respective elongate and outwardly opening channels 77A and 78 which are located adjacent the respective through holes 76 and 77, respectively. The channels 77A and 78 extend along the entire longitudinal extent of the respective slat. The slats 70 and the rear slat 71 each have longitudinal and height dimensions similar to, but slightly less than, the longitudinal and height dimensions of the cartridge 12.

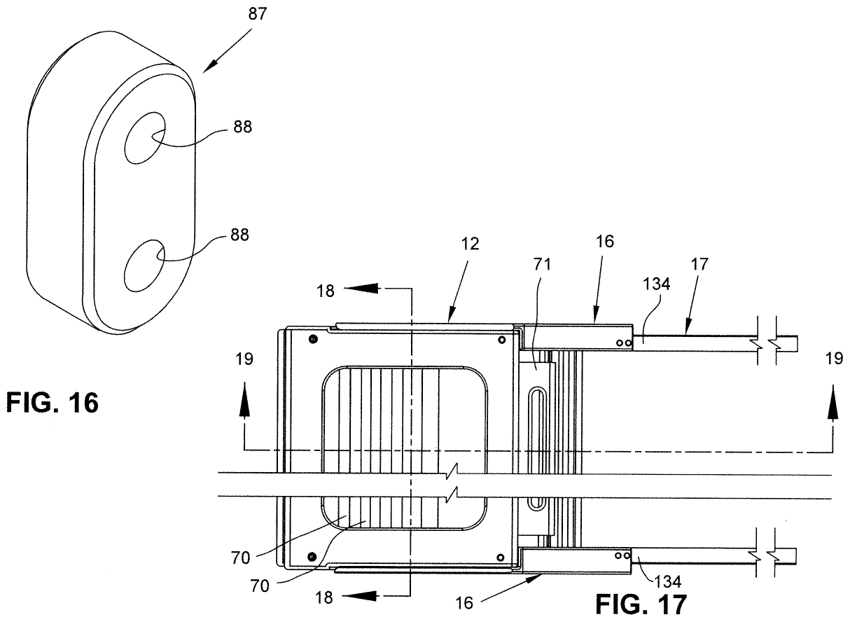

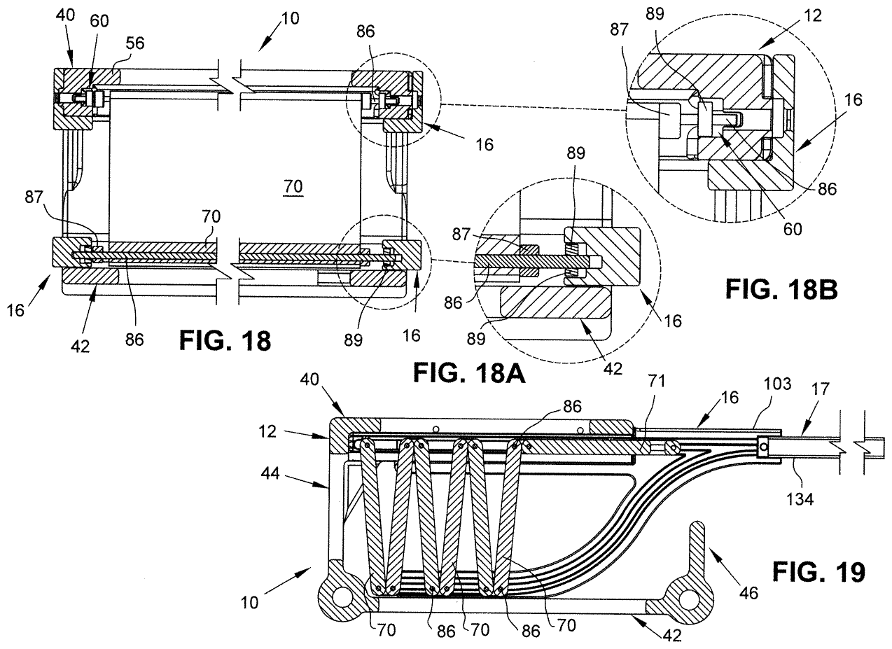

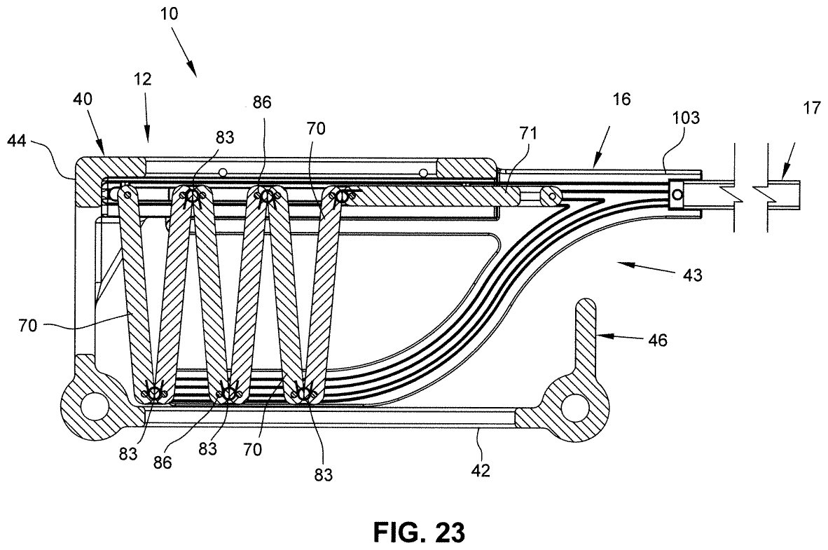

Turning now to the slat linkage assembly 18 and as best shown in FIGS. 23-25, the assembly 18 includes a slat sealing arrangement including a plurality of elongated and elastomeric seals 80. Each seal 80 in the illustrated embodiment includes an elongated sealing portion 81 and a pair of seal mounts 82 attached to and extending along respective opposite longitudinal edges of the sealing portion 81. The seals 80 cooperate with the channels 77A and 78 of the slats 70 and 71 as discussed further below. The slat linkage assembly 18 further includes a plurality of springs 83 (shown only in FIG. 23), which springs 83 in the illustrated embodiment are torsion springs. Each spring 83 is mounted between and interconnects a pair of adjacent ones of the slats when same are joined to one another and located within the cartridge 12, as also discussed below. With reference to FIGS. 4, 16 and 23-25, the slat linkage assembly 18 further includes a plurality of elongate and rigid rods 86 and a plurality of slat connectors 87. Each slat connector 87 includes a through-opening 88 at each of its opposite ends. Additionally, the slat linkage assembly 18 includes a plurality of bearings or rollers 89. The bearings 89 in the illustrated embodiment are ball bearings.

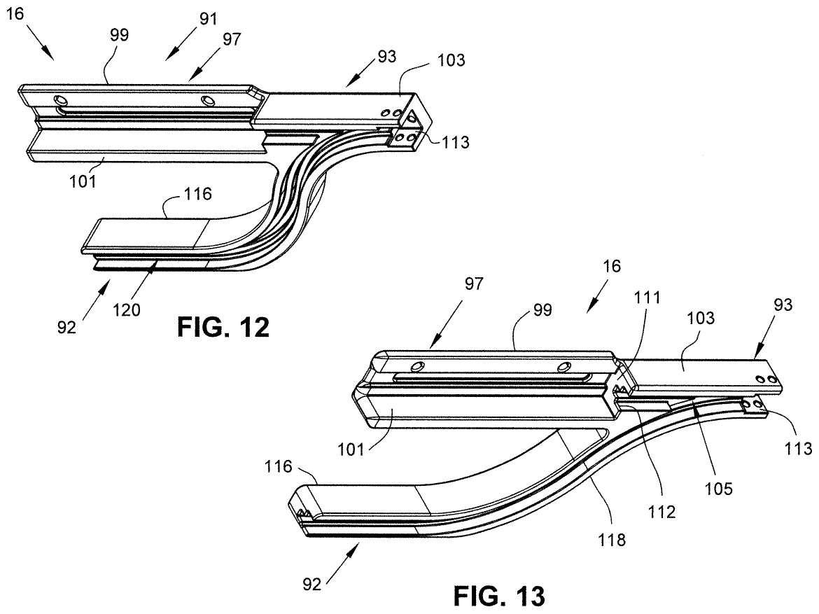

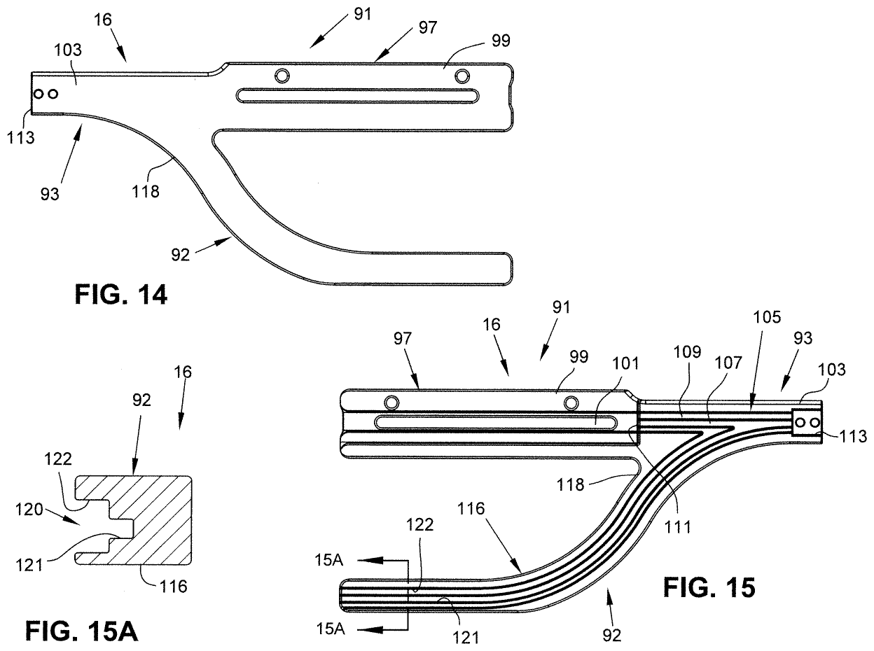

As illustrated in FIGS. 4 and 10-15 and 15A, the cartridge side frames 16 will now be described and are mirror images of one another. Only one of the cartridge side frames 16 will accordingly be described here. The cartridge side frame 16 includes a generally straight upper portion 91 and a lower curved portion 92. The upper and lower portions 91 and 92 are joined to one another at a rear end portion 93 of the cartridge side frame 16. The upper portion 91 includes a cartridge-mounting segment 97 having an upper mounting flange 99 and a lower mounting flange 101 joined to a lower edge portion of the upper mounting flange 99 and oriented transversely relative thereto. The rear end portion 93 includes a rear track segment 103 which is generally U-shaped in cross-section and defines in an interior thereof a stepped track 105 which opens inwardly and has substantially the same cross-sectional configuration as the stepped tracks 60 of the upper frame 40 of the cartridge 12. Specifically, the stepped track 105 has an outer elongate track part 107 and an inner elongate track part 109 in communication with the outer track part 107, and the inner track part 109 is of a greater vertical dimension than the outer track part 107. The rear track segment 103 has a generally upright and interior track entry wall 111 located at a front end thereof. As best shown in FIG. 13, the track entry wall 111 defines therein a stepped track 112 having substantially the same cross-sectional configuration as the stepped tracks 60 and 105 of the upper frame 40 and the rear track segment 103. Further, the stepped track 112 of the track entry wall 111 is aligned with and communicates with the stepped tracks 60 and 105 of the upper frame 40 and the rear track segment 103. The stepped track 105 accordingly opens frontwardly through the stepped track 112 of the track entry wall 111, and rearwardly through an open terminal end 113 of the rear track segment 103.

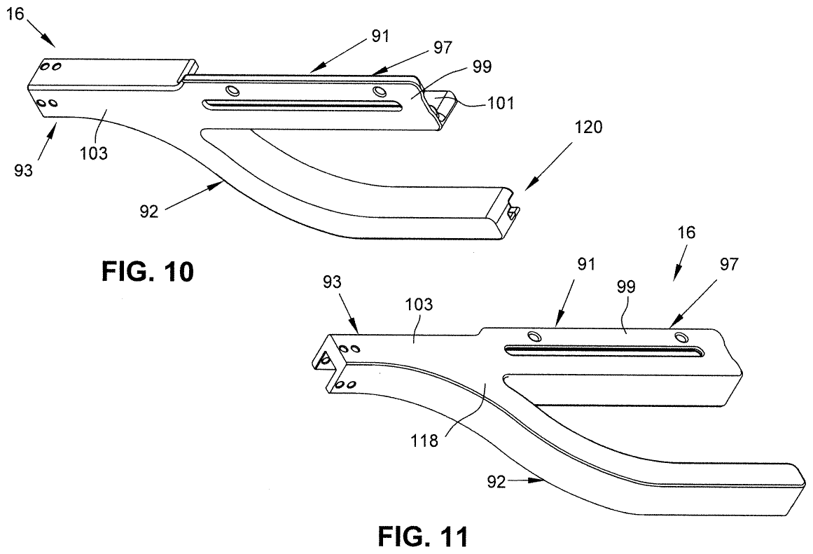

With continued reference to FIGS. 10-15 and 15A, the lower curved portion 92 of the cartridge side frame 16 includes a lower track segment 116 which defines in an interior thereof a curved stepped track 120 which opens inwardly and has substantially the same cross-sectional configuration as the stepped track 105 of the rear track segment 103. Specifically, the stepped track 120 has an outer elongate track part 121 and an inner elongate track part 122 in communication with the outer track part 121, and the inner track part 122 is of a greater vertical dimension than the outer track part 121. The lower curved portion 92 additionally has an upper end portion 118 joined to the upper portion 91 of the cartridge side frame 16 adjacent the track entry wall 111. Further, the stepped track 120 of the lower curved portion 92 in the illustrated embodiment extends along substantially the entire extent of the lower curved portion 92 of the cartridge side frame 16 and merges with the stepped track 105 of the rear end portion 93 of the cartridge side frame 16 at this upper end portion 118.

The channel members 17, as shown in FIGS. 1, 4 and 29 are substantially identical to one another and only one of same will therefore be described. The channel member 17 is generally U-shaped, which U-shape is defined by substantially parallel and elongate top and bottom walls 130 and 131 which are joined to one another by an elongate side wall 132. The top wall 130, bottom wall 131 and side wall 132 together define an elongate channel 133. In one embodiment, the side wall 132 of each channel member 17 defines therein one or more slots 135 distributed in spaced relation along the length of the channel member 17. The channel members 17 have respective front ends 134 which are oriented adjacent the respective rear track segments 103 of the cartridge side pieces 16, and so that their channels 133 open inwardly and towards one another.

The slats 70 and 71 of the slat assembly 14 are assembled in an accordion-style configuration, in accordance with one method of assembly, as follows. One rod 86 is inserted into each of the upper and lower through-holes 76 and 77 of the respective slats 70 and 71. The slats 70 are arranged in a side-by-side configuration with one another and the upper end portions 73 of two adjacent slats 70 are interconnected to one another by installing one connector 87 onto the terminal ends of the respective rods 86 by extending the ends of the rods 86 into the respective connector openings 88. One bearing 89 is then installed onto the end of each rod 86 so that the connector 87 is sandwiched between the lateral edge portions 75 of the adjacent slats 70 and the two bearings 89. The lower end portion 74 of each of the two interconnected slats 70 is connected to the lower end portion 74 of the next-adjacent slat 70 in a similar manner as described above (see FIG. 25). Adjacent pairs of slats 70 are interconnected to one another in this manner until all slats 70 are connected. The end portion of the rear slat 71 opposite the opening/handle 72 thereof is connected to the slat 70 located at the end of the stack of interconnected slats 70 in the manner described above. Additionally and as shown in FIG. 23, at least one spring 83 is installed onto two adjacent and interconnected slats 70 and onto the interconnected end and rear slats 70 and 71. In this regard, the slats 70 at each of their upper and lower end portions 73 and 74, and the rear slat 71 at its end portion opposite the opening/handle 72 thereof, are appropriately configured to receive part of the spring 83. The springs 83 exert an inward pulling force on the slats 70 and 71 and bias the adjacent and interconnected pairs of slats towards one another.

With reference to FIGS. 24 and 25, interconnected ones of the slats are sealed with a seal 80 of the slat sealing arrangement. More specifically, a seal 80 is installed onto the upper end portions 73 and onto the lower end portions 74 of interconnected slats 70 as follows. The seal mount 82 of the seal 80 is inserted into the channel 77A at the upper end portion 73 of one slat 70 and the opposite seal mount 82 is inserted into the channel 77A of the adjacent slat 70 so that the joint area or seam between the upper end portions 73 is covered by the seal 80. A further seal 80 is then installed onto the lower end portions 74 of interconnected slats 70 in the same manner. A seal 80 is also installed between the end portion 73 of the endmost slat 70 and the end portion of the rear slat 71 opposite the opening/handle 72.

The cartridge side frames 16 are assembled to the cartridge 12 by positioning the cartridge side frames 16 on opposite sides of the cartridge 12 so that the lower mounting flanges 101 of the side frames 16 extend under the respective upper frame members 56 of the cartridge upper wall 40, which positions the upper mounting flanges 99 of the cartridge mounting segments 97 of the respective side frames 16 against the outer sides of the respective upper frame members 56. Fasteners are then used to secure the side frames 16 to the cartridge 12.

The assembled slats 70 are positioned within the cartridge 12 and the side frames 16 so that the terminal ends of the rods 86 at the upper end portions 73 on opposite lateral sides of the slats 70 are seated in the respective outer track parts 62 of the stepped tracks 60 of the upper frame members 56 of the cartridge 12, and so that the corresponding upper bearings 89 are seated in the respective inner track parts 64 of the stepped tracks 60 of the upper frame members 56. Further, the terminal ends of the rods 86 at the lower end portions 74 on opposite sides of the slats 70 are seated in the respective outer track parts 121 of the stepped tracks 120 of the lower portions 92 of the respective side frames 16, and so that the corresponding lower bearings 89 are seated in the respective inner track parts 122 of the stepped tracks 120 of the lower side frame portions 92. As shown in FIG. 19, the rear slat 71 is positioned horizontally within the cartridge 12 and cartridge side frames 16. Specifically, the terminal ends of the rods 86 located at the end portion of the slat 71 (connected to the adjacent end slat 70) and the terminal ends of the rods 86 at the free end of the slat 71 (adjacent the opening/handle 72) are positioned in the respective outer track parts 62 of the stepped tracks 60 of the upper frame members 56 of the cartridge 12, and so that the corresponding upper bearings 89 are seated in the respective inner track parts 64 of the stepped tracks 60 of the upper frame members 56. The rear slat 71 as shown in FIG. 19 is positioned so as to extend slightly out of the cartridge 12 and into the rear track segments 103 of the respective side frame members 16, so that the terminal ends of the rods 86 and the corresponding bearings 89 located at the free end portion of the rear slat 71 are seated within the outer track parts 107 and the inner track parts 109, respectively, of the rear end portions 93 of the respective cartridge side frames 16. However, it will be appreciated that the slat assembly 14 in a fully retracted position in one embodiment has the free end portion of the slat 71 adjacent the opening/handle 72 fully housed within the cartridge 12 in a horizontal orientation. The rear ends 134 of the rails or channel members 17 are respectively fastened to the respective ends 113 of the rear track segments 103 of the respective cartridge side frames 16 with suitable fasteners.

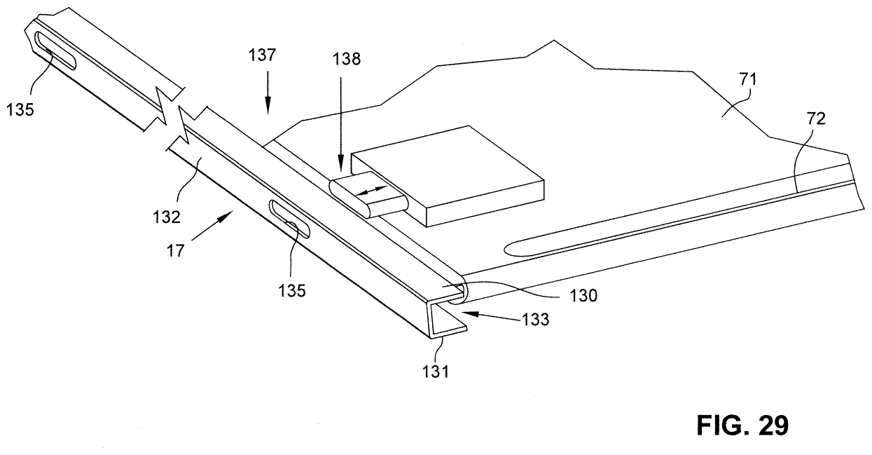

As best shown in FIGS. 4 and 29, the arrangement 10 further includes a locking arrangement 137 which cooperates between the channel members 17 and the rear slat 71. In this regard, the rear slat 71 mounts thereon sliding locks 138 on opposite sides thereof (only one of which is shown in FIG. 29), which locks 138 are slidably movable relative to the rear slat 71 towards and away from the respective adjacent channel member 17. The sliding locks 138 cooperate with the openings 135 defined in the respective adjacent channel members 17 to lock the arrangement 10 in a selected extended position, as discussed further below. It will be appreciated that the above-described locking mechanism is only one type of locking mechanism which can be utilized with the arrangement 10, and other types of locking mechanisms may be utilized. For example, the lock arrangement 137 may instead include spring-loaded locks installed on the rear slat 71 which, when aligned with the openings 135 of the channel members 17, automatically engage in the respective openings 135.

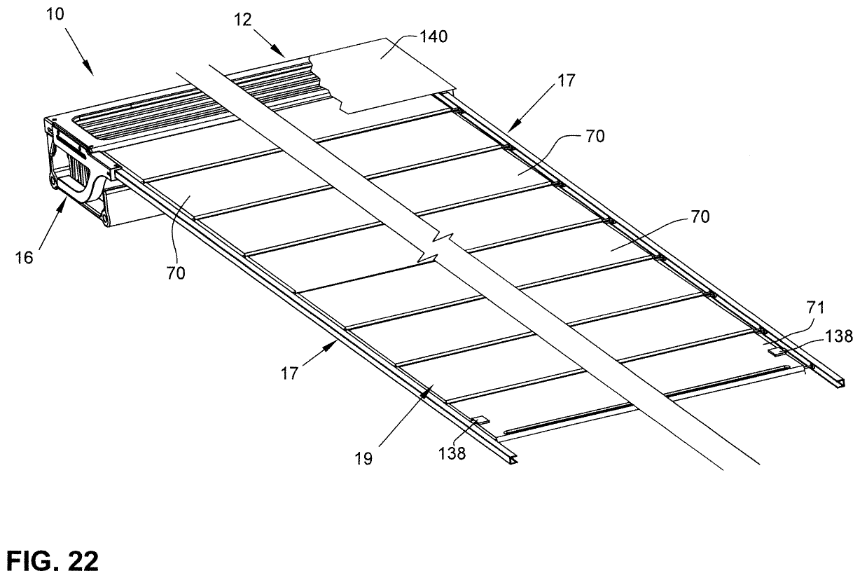

The assembled arrangement 10 is mounted, in accordance with one use of the arrangement 10, inside the bed 21 of the pickup truck 20 adjacent the front wall 24 and below the rear view window, as shown in FIG. 2. In this regard, the arrangement 10 is mounted to the front wall 24 and/or the side walls 22 with suitable brackets (not shown), so that the mouth 43 of the cartridge 12 faces rearwardly. Further, the channel members 17 are respectively fixed to the inside of the side walls 22 of the bed 21 so that the channel members 17 extend parallel to one another along upper edge portions of the side walls 22 with the channels 133 facing inwardly and toward one another. As shown in FIG. 22, the arrangement 10 includes a cover 140 which is shown fragmented in FIG. 22 but which extends along the entire extent of the assembled cartridge 12 and cartridge side pieces 16 so as to seal same from the environment.

In operation, with the arrangement 10 mounted in the vehicle 20 and in the fully retracted or stored configuration, the user grasps the rear slat 71 via the opening/handle 72 and pulls the rear slat 71 in a direction away from the front wall 24. Continued pulling on the rear slat 71 causes the interconnected trailing slats 70 to undergo the motions shown in FIGS. 19-21, so that the trailing slats 70 exit the mouth 43 of the arrangement 10 one-by-one and assume a horizontal orientation until the fully extended covering configuration is reached as shown in FIGS. 2 and 22. The slat assembly 14 in the fully extended position can then be locked using the lock arrangement 137. Specifically, the rear slat 71 in the fully extended position of the slat assembly 14 is positioned relative to the respective channel members 17 so that sliding locks 138 are aligned with the rearmost openings 135 of the channel members 17, and the locks 138 are extended outwardly and into the respective rearmost openings 135 to lock the arrangement 10. If it is desirable to only partially extend the slat assembly 14, the rear slat 71 may be aligned with other openings 135 located forwardly of the rearmost openings 135 and the sliding locks 138 engaged within these openings 135.

To retract the slat assembly 14, the user disengages the locks 138 from the openings 135 in the channel members 17 and pushes the rear slat 71 towards the front wall 24 of the vehicle 20. The biasing force of the springs 83 exerts a retracting force on the slat assembly 14, and when the arrangement 10 is unlocked as described above and the rear slat 71 is pushed in a direction away from the user, the slat assembly 14 will easily and readily collapse and fold into the retracted stored configuration without user strain.

If the arrangement 10 is utilized as a door or as a protective cover for a door or window, the slat assembly 14 is extended and retracted in a similar manner to that described above.

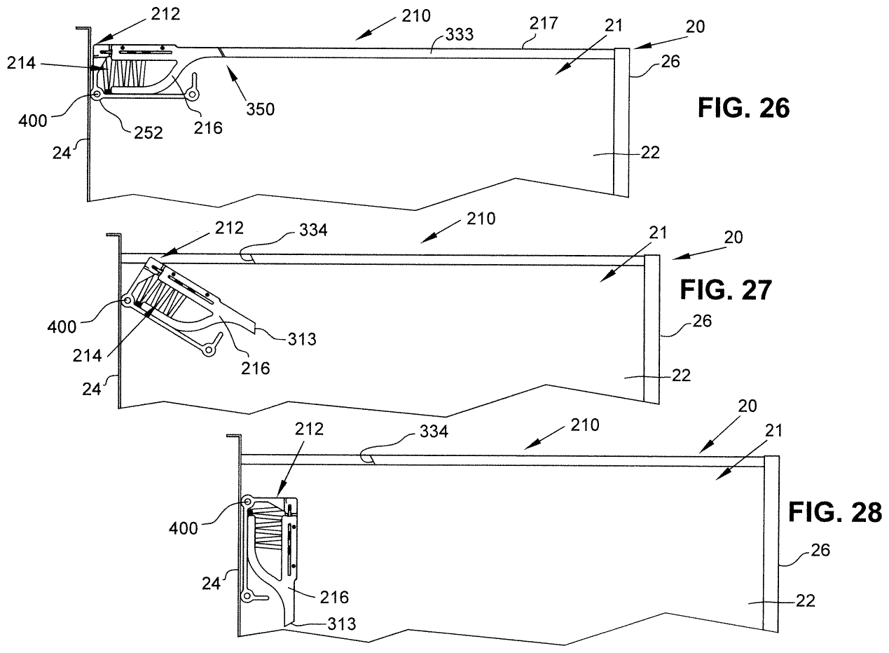

FIGS. 26-28 illustrate an additional embodiment of the arrangement. The arrangement 210 is substantially identical to the arrangement 10 described previously, and the same or similar components will be referenced with the same reference numerals, plus 200. The arrangement 210 incorporates a modification of the rear ends of the cartridge side frames 216 and the front ends of the channel members 217. In this regard, the arrangement 210 as a whole, except for the channel members 217, is mounted to the vehicle 20 for pivoting movement about an axis 400. In the illustrated embodiment, the pivot axis 400 is horizontally oriented and extends transversely between the side walls 22 of the vehicle 20. More specifically, the cylinder 252 of the cartridge 212 may be used for this purpose and may receive a pivot rod (not shown) fixedly mounted to the front wall 24 and/or to the respective side walls 22 of the vehicle 20 so that the arrangement 210 is pivotable between an upper use position shown in FIG. 26 and a lower storage or non-use position shown in FIG. 28. In order to accommodate this movement of the arrangement 210, the arrangement includes, according to one embodiment, wedge connections 350 between the ends 313 of the respective side cartridge pieces 216 and the ends 334 of the respective channel members 217. The ends 313 and 334 are angled appropriately so that when the arrangement 210 is in the upper use position of FIG. 26, the ends 313 and 334 mate with one another so as to form a continuous channel 333 at the junction of the ends 313 and 334, and so that when use of the arrangement 210 is not needed the ends 313 and 334 permit the side cartridge pieces 216 to separate from the respective channel members 217 when the arrangement 210 pivots downwardly about the axis 400 as shown in FIG. 27.

The arrangement 210 further includes slam latches or locks at its opposite ends which cooperate with the channel members 217 and/or with the side walls 22 of the vehicle 20, so that when it is desirable to store the arrangement 210 the slam latches are disengaged which releases the arrangement 210 and allows same to pivot downwardly and ultimately to rest against the front wall 24 of the vehicle 20. The arrangement 210 in this position thus allows more use of the bed 21 without having to uninstall the arrangement 210 from the vehicle 20. When use of the arrangement 210 is again desired, the arrangement 210 is pivoted upwardly until the slam locks engage once again and hold the arrangement 210 in the upper use position.

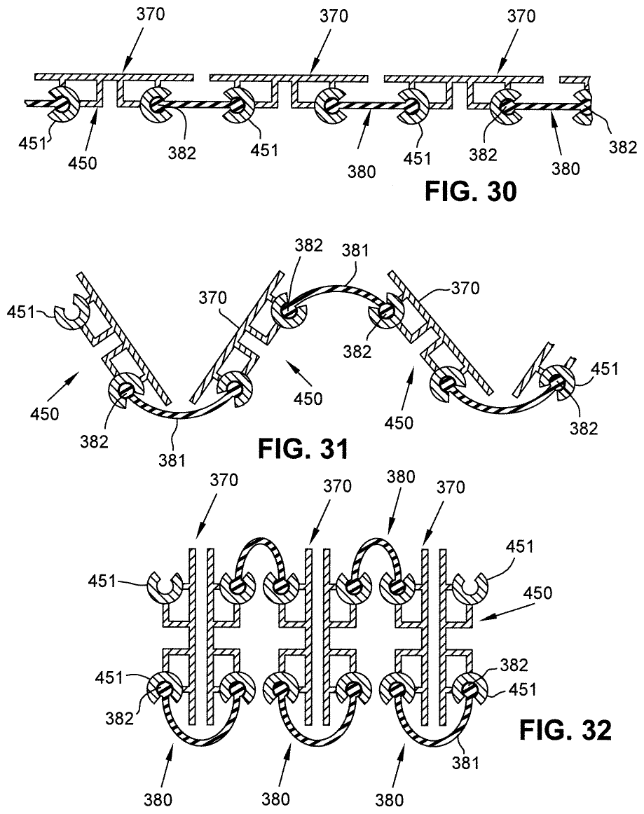

FIGS. 30-32 illustrate an alternative arrangement of the slat sealing arrangement and the same reference numbers, plus 300, will be utilized for identical or similar components. Each of the slats 370 in this embodiment, instead of including seal-mounting channels as in the prior embodiment, include a frame 450 on one side thereof having respective seal-mounting channels 451 which open outwardly and away from one another. Each seal 380 is mounted between adjacent slats 370 as in the prior embodiment, by engaging the seal mounts 382 thereof in the respective seal-mounting channels 451 of the adjacent slats 370.

The arrangements 10 and 210 described herein are of a lightweight and robust construction, and may be constructed of aluminum or composite materials, which simplifies installation and handling. Additionally, it will be appreciated that the dimensions of the cartridge 12, 212 and the accompanying cartridge side frames 16, 216 may vary from what is shown so as to accommodate slats of different dimensions to allow multiple uses of the disclosed arrangements.

While the arrangements 10 and 210 are disclosed herein as including slat assemblies which are manually extended and retracted by the user, it will be appreciated that the arrangements 10 and 210 can be utilized with an electric drive system operatively connected to the rear slat 71, which rear slat 71 in turn drives the slats 70. Such electric drive systems may include flex drive systems and/or cable drum systems.

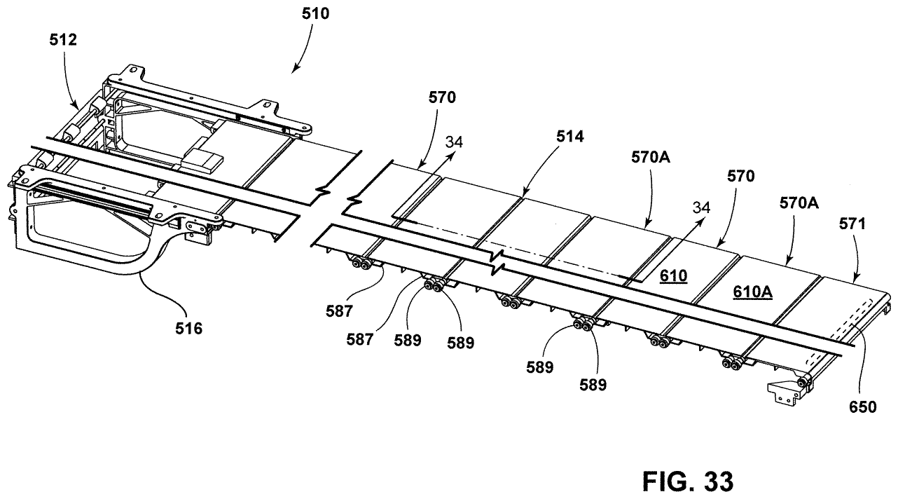

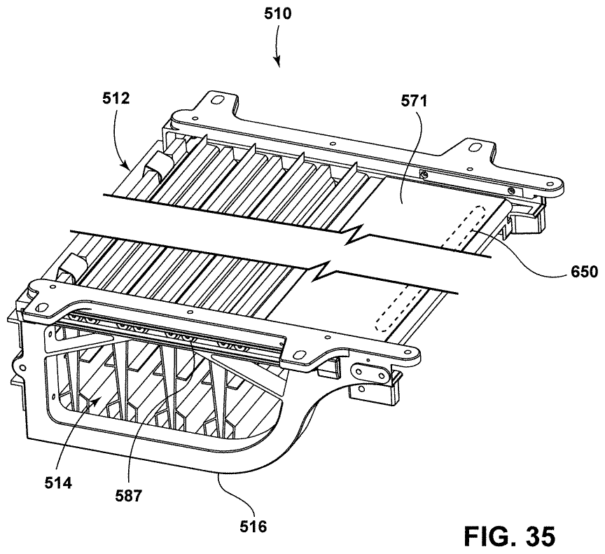

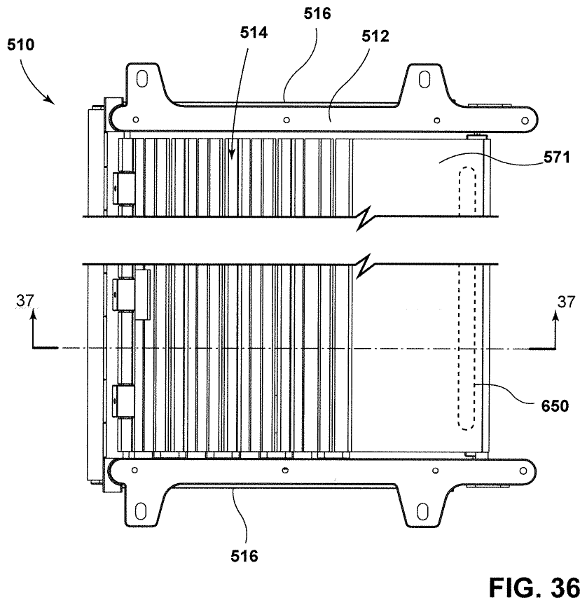

FIGS. 33-37 illustrate an alternative cover or door arrangement 510 which is substantially similar to the prior arrangements 10 and 210, but includes a modified slat sealing arrangement. The same reference numbers, plus 500, will be utilized for identical or similar components and a detailed discussion of same will not be included here. The arrangement 510 includes a magazine or housing or cartridge 512, a pair of cartridge side frames 516, a pair of channel members or rails (not shown) a slat assembly 514 and a slat linkage assembly. All components of the slat linkage assembly are not shown here for simplicity, except that the slat connectors 587 and the bearings or rollers 589 can be seen in FIGS. 33 and 35. As is the case with the prior embodiments, the slat assembly 514 is normally housed within the cartridge 512 and is extendable therefrom.

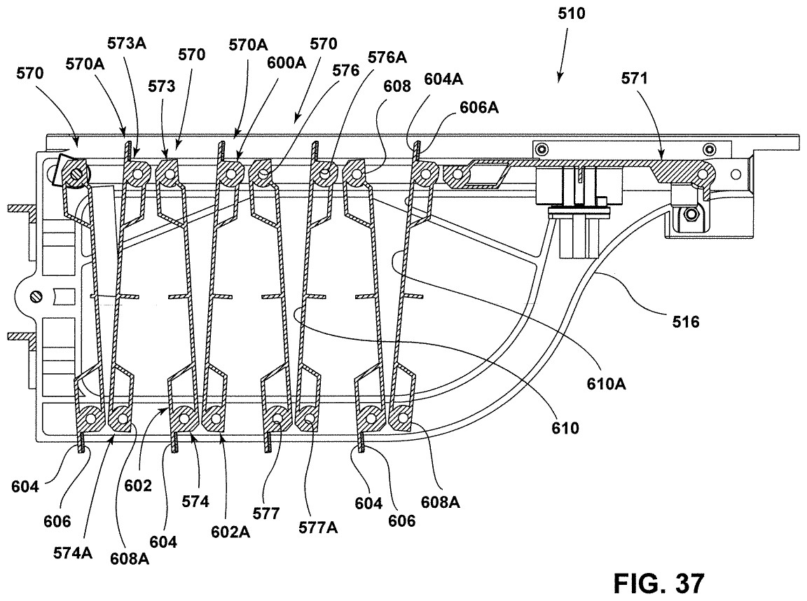

The slat assembly 514 includes a plurality of individual and generally planar and elongated slats 570, 570A and a rear generally planar and elongated slat 571. The slats 570 and 570A are substantially identical to one another and are arranged in the housing 512 in an alternating manner with one another as shown in FIGS. 35 and 37, with the end slat 571 located at the leading end of the slat assembly 514 which leaves the housing first 512 when the slat assembly 514 is extended into the covering position. The slats 570 and 570A each include elongate upper end portions 573 and 573A with respective through holes 576 and 576A, and elongate lower end portions 574 and 574A each with respective through holes 577 and 577A.

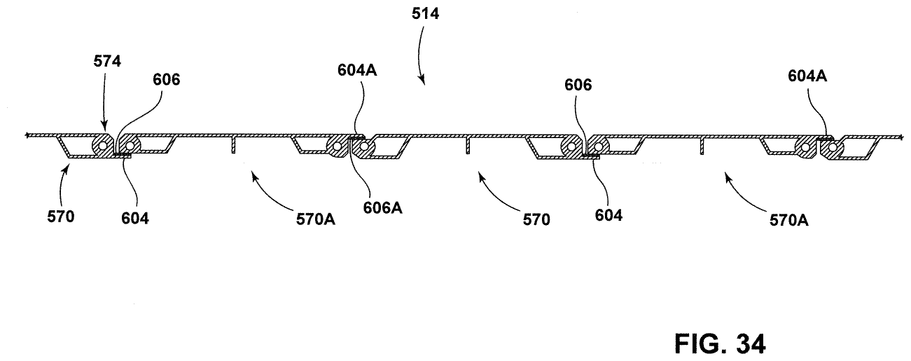

With reference to FIGS. 34 and 37, the lower end portions 574 of the slats 570 and the upper end portions 573A of the slats 570A in the illustrated embodiment each include a box-type frame which mounts thereon a generally planar flange 604 and 604A, respectively, which flanges 604 and 604A each have fixed thereon a seal 606 and 606A. The flanges 604 and 604A project outwardly from the respective slats 570 and 570A, and are generally coplanar with planar walls 610 and 610A of the respective slats 570 and 570A. Additionally, the upper end portions 573 of the slats 570 and the lower end portions 574A of the slats 570A each define thereon a seal surface 608 and 608A. The flanges 604 and 604A and the seals 608 and 608A fixed thereto extend along substantially the entire longitudinal extent of the slats 570 and 570A.

As shown in FIG. 34, when the slat assembly 514 is in the extended configuration, the seal 606 of each of the slats 570 seats against the seal surface 608A of the immediately adjacent and interconnected one of the slats 570A, which effectively prevents water from traveling between the slats 570 and 570A and into the storage space covered by the slats 570 and 570A when extended. When the slat assembly 514 is retracted as shown in FIG. 37, the seals 606 and 606A are disengaged from their respective seal surfaces 608 and 608A.

It will be appreciated that the arrangement 510 depicted in FIGS. 33-37, as with all prior arrangements disclosed herein, may be incorporated into the motor vehicle 20, or pickup truck, or may instead be utilized in a front or rear cargo space of a passenger vehicle. Alternatively, the arrangement 510 may be incorporated into a building or a permanent or temporary storage structure, such as that shown in FIG. 3.

Additionally, the arrangement 510 may incorporate a handle member 650 (shown in dotted lines in FIGS. 33, 35 and 36) on the rear slat 571 to facilitate manual opening and closing of the slat assembly 514. Alternatively, the arrangement 510 may be utilized with an electric drive system operatively connected to the rear slat 571, which rear slat 571, in turn, drives the slats 570 and 570A.

Although particular preferred embodiments of the door or cover arrangement have been disclosed in detail for illustrative purposes, it will be recognized that variations or modifications of the disclosed arrangement, including the rearrangement of parts, lie within the scope of the invention.

What is claimed is:

1. A cover or door arrangement comprising:
a housing defining a hollow interior and a mouth, said hollow interior of said housing opening outwardly to an exterior environment of said cover or door arrangement through said mouth; and
a slat assembly movable between a retracted storage configuration and an extended covering configuration, said slat assembly when in said retracted storage configuration being disposed substantially within said housing, said slat assembly including a plurality of rigid slats each having first and second elongate and spaced-apart longitudinal edge portions and first and second spaced-apart side edge portions interconnecting said first and second longitudinal edge portions, each of said slats having oppositely facing first and second sides and said first sides each have a substantially planar exterior surface portion facing outwardly, said exterior surface portions being oriented in a substantially coplanar manner with one another when said slat assembly is in said extended covering configuration, two of said plurality of slats are endmost slats and remaining ones of said plurality of slats are central slats disposed between said endmost slats, each of said central slats in said retracted storage configuration being sandwiched between two other adjacent ones of said central slats or between an adjacent one of said central slats and one of said endmost slats with said first sides being disposed in substantially facing relation with one another, said first longitudinal edge portion of each said central slat being pivotably connected to said first longitudinal edge portion of an adjacent one of said central slats disposed on one side thereof, and said second longitudinal edge portion of each said central slat being pivotably connected to said second longitudinal edge portion of an adjacent one of said central slats disposed on an opposite side thereof or pivotably connected to said second longitudinal edge portion of one of said endmost slats to provide said slat assembly with an accordion configuration, one of said endmost slats being positioned in said slat assembly such that said one endmost slat is a first of said plurality of slats to exit said housing through said mouth thereof when said slat assembly is moved from said retracted storage configuration to said extended covering configuration.

2. The cover or door arrangement according to claim 1, wherein said slat assembly further comprises a handle operatively connected to said one endmost slat for manually moving said slat assembly between said retracted storage configuration to said extended covering configuration.

3. The cover or door arrangement according to claim 1, wherein said housing has first and second spaced-apart sides oriented transversely to said mouth and said cover or door arrangement further comprises first and second spaced apart and elongated track members disposed along the respective said first and second sides of said housing, said first and second side edge portions of said slats being disposed adjacent the respective said first and second track members when said slat assembly is in said retracted storage configuration within said housing.

4. The cover or door arrangement according to claim 3, wherein each of said first and second track members includes at least one elongated track, said at least one elongated tracks of said first and second track members opening inwardly and towards one another, and said slat assembly includes at least one roller fixed to each said slat adjacent said first and second side edge portions thereof, said rollers being movably engaged within said first and second track members to permit movement of said slat assembly between said retracted stored configuration and said extended covering configuration.

5. The cover or door arrangement according to claim 4, wherein said first and second longitudinal edge portions of said central slats and said endmost slats are oriented transversely relative to and extend between said first and second track members when said slat assembly is in said retracted stored configuration.

6. The cover or door arrangement according to claim 5, wherein each said at least one elongated track of said first and second track members comprises two spaced-apart first and second track portions, said slat assembly comprises a plurality of connectors and some of said connectors pivotably connect each said first longitudinal edge portion of each said central slat to said first longitudinal edge portion of said adjacent one of said central slats disposed on said one side and remaining ones of said plurality of connectors pivotably connect each said second longitudinal edge portion of each said central slat to said second longitudinal edge portion of said adjacent one of said central slats disposed on said opposite side thereof or to said second longitudinal edge portion of said one endmost slat, said slat assembly includes a plurality of said rollers and one said roller is disposed adjacent each of said connectors, said rollers disposed adjacent said connectors interconnecting said first longitudinal edge portions being movably disposed in said first track portions and said rollers disposed adjacent said connectors interconnecting said second longitudinal edge portions being movably disposed in said second track portions.

7. The cover or door arrangement according to claim 6, wherein said first track portion is substantially linear and said second track portion has a substantially linear portion substantially parallel to and spaced from said first track portion and an arcuately curved portion joined to said substantially linear portion and curving towards said first track portion, said arcuately curved portion adjoining said first track portion adjacent said mouth of said housing.

8. The cover or door arrangement according to claim 3, wherein said first and second spaced-apart and elongated track members disposed along the respective said first and second sides of said housing extend beyond said mouth of said housing and support said slat assembly when in said extended covering configuration.

9. The cover or door arrangement according to claim 1, further including a seal member extending along and between each pair of interconnected first longitudinal edge portions of said slats and a seal member extending along and between each pair of interconnected second longitudinal edge portions of said slats.

10. The cover or door arrangement according to claim 9, wherein each said seal member is mounted on one of said first longitudinal edge portions of each pair of interconnected first longitudinal edge portions and a sealing surface is defined on the other of said first longitudinal edge portions of each pair of interconnected first longitudinal edge portions, said seal members sealingly engaging the sealing surfaces when said slat assembly is in said extended covering configuration.

11. A cover or door arrangement comprising:
a housing defining a hollow interior and a mouth, said hollow interior of said housing opening outwardly to an exterior environment of said cover or door arrangement through said mouth, said housing including first and second spaced-apart sides oriented transversely to said mouth;
a pair of elongate and spaced-apart track members disposed along the respective said first and second sides of said housing; and
a slat assembly movable between a retracted storage configuration and an extended covering configuration, said slat assembly when in said retracted storage configuration being disposed substantially within said housing, said slat assembly including a plurality of rigid slats pivotably interconnected to one another in an end-to-end manner in an accordion configuration and movably engaged with said track members, each of said slats having oppositely facing first and second sides with said first sides having an exterior surface portion facing outwardly when said slat assembly is in said extended covering configuration, said exterior surface portions when said slat assembly is in said extended covering configuration being oriented in a substantially coplanar manner with one another, one of said slats being an end slat positionally disposed in said slat assembly such that said one end slat is a first of said slats to exit said housing through said mouth thereof when said slat assembly is moved from said retracted storage configuration to said extended covering configuration, and said slat assembly further comprises a handle operatively connected to said one end slat for manually moving said slat assembly between said retracted storage configuration and said extended covering configuration.

12. The cover or door arrangement according to claim 11, wherein said arrangement further comprises first and second spaced apart and elongated track members disposed along the respective said first and second sides of said housing.

13. The cover or door arrangement according to claim 12, wherein each of said first and second track members includes at least one elongated track, said at least one elongated tracks of said first and second track members opening inwardly and towards one another, and said slat assembly includes at least one roller fixed to each said slat adjacent respective spaced-apart side edge portions thereof, said rollers being movably engaged within said first and second track members to permit movement of said slat assembly between said retracted stored configuration and said extended covering configuration.

14. The cover or door arrangement according to claim 13, wherein each said slat and said end slat has first and second elongate and spaced-apart longitudinal edge portions and first and second spaced-apart side edge portions interconnecting said first and second longitudinal edge portions, said first and second longitudinal edge portions of said slats and said end slat being oriented transversely relative to and extending between said first and second track members when said slat assembly is in said retracted stored configuration.

15. The cover or door arrangement according to claim 14, wherein said slats are pivotably interconnected to one another along said first and second longitudinal edge portions, and said arrangement further includes a seal member extending along and between each pair of interconnected first longitudinal edge portions of said slats and a seal member extending along and between each pair of interconnected second longitudinal edge portions of said slats.

16. The cover or door arrangement according to claim 15, wherein each said seal member is mounted on one of said first longitudinal edge portions of each pair of interconnected first longitudinal edge portions and a sealing surface is defined on the other of said first longitudinal edge portions of each pair of interconnected first longitudinal edge portions, said seal members sealingly engaging the sealing surfaces when said slat assembly is in said extended covering configuration.
